(19) United States
(12) Patent Application Publication
(10) Pub. No.: US 2026/0200026 A1
(43) Pub. Date: Jul. 16, 2026

(54) TOOL CHANGER

(71) Applicant: FANUC CORPORATION, Yamanashi (JP)

(72) Inventor: Gaku ISOBE, Yamanashi (JP)

(73) Assignee: FANUC CORPORATION, Yamanashi (JP)

(21) Appl. No.: 19/134,482

(22) PCT Filed: Dec. 7, 2022
(86) PCT No.: PCT/JP2022/045177

§ 371 Date: May 30, 2025

(51) Int. Cl. B23Q 3/157; B23Q 3/155

(52) U.S. Cl. CPC B23Q 3/15722; B23Q 3/15534; B23Q 2003/155428

(57) ABSTRACT

The objective of the present invention is to facilitate an overlap of operations for gripping and releasing tools with other operations of an arm. This tool changer comprises a magazine, an arm, and a grip interlocking mechanism. The magazine has a magazine body and multiple tool pots attached to the magazine body. One of the multiple tool pots is placed in a changing position by rotation of the magazine body. The arm has first and second gripping members. The arm uses one of the gripping members to remove a tool to be used next from the tool pot in the changing position and attach this tool to a main spindle, and the other gripping member to remove a previously used tool from the main spindle and attach this tool to the tool pot in the changing position. The grip interlocking mechanism causes the magazine-side gripping member to rotate to grip/release the tool in an interlocked manner with movement of the arm relative to the magazine, and the main spindle-side gripping member to rotate to grip/release the tool in an interlocked manner with the movement of the arm relative to the main spindle.

### TECHNICAL FIELD

The present disclosure relates to a tool changing device that changes a tool attached to a spindle of a machine tool.

### BACKGROUND ART

Some tool changing devices detach a previously-used tool as one of a plurality of tools from the spindle and attach a subsequently-used tool as a tool different from the previously-used tool to the spindle.

### CITATION LIST

### Patent Document

Patent Document 1: Japanese Unexamined Patent Application, Publication No. 2008-132555

### DISCLOSURE OF THE INVENTION

### Problems to be Solved by the Invention

More specifically, some tool changing devices include a magazine and an arm. The magazine has a plurality of tool pots to which tools are respectively attachable, and one of the plurality of tool pots is disposed at the lowermost change position by the rotation of the magazine around the horizontal axis. The arm has two grip portions. The arm slightly pivots in a predetermined direction around the vertical direction to cause one grip portion to grip the subsequently-used tool of the tool pot in the change position and cause the other grip portion to grip the previously-used tool in the spindle. In this state, the arm is lowered to detach the subsequently-used tool from the tool pot and to detach the previously-used tool from the spindle.

Next, the arm pivots 180 degrees around the vertical direction. This causes switching between the position of the subsequently-used tool and the position of the previously-used tool. Next, by raising the arm, the subsequently-used tool is attached to the spindle and the previously-used tool is attached to the tool pot. From this state, the arm slightly pivots in the direction opposite to the predetermined direction described above, whereby the grip portion on the spindle side releases the gripping of the subsequently-used tool and the grip portion on the magazine side releases the gripping of the previously-used tool.

The present disclosers focused on the following problem in such a configuration. When gripping and releasing the gripping of the subsequently-used tool and the previously-used tool by slightly pivoting the arm around the up-down direction, it is necessary to move the arm in the up-down direction relative to the magazine or the spindle after the pivoting of the arm is firmly stopped. Therefore, it is difficult to cause acceleration/deceleration operations for gripping and releasing the gripping of the tool to overlap other operations such as raising and lowering of the arm. Therefore, it is difficult to shorten the cycle time of tool change.

The present disclosure has been made in view of the above circumstances, and an object of the present disclosure is to make it easier to overlap other operations of an arm with operations for gripping and releasing of the gripping of a tool.

### Means for Solving the Problems

A tool changing device for detaching a previously-used tool as one of a plurality of tools from a spindle of a machine tool and attaching a subsequently-used tool as a tool different from the previously-used tool to the spindle, includes:
a magazine including a rotatable magazine body and a plurality of tool pots attached to the magazine body, the plurality of tools being respectively attachable to the plurality of tool pots, one of the plurality of tool pots being disposed at an change position by rotation of the magazine body;
an arm including a first grip member and a second grip member, the first grip member and the second grip member each being rotatable around a direction orthogonal to an axial length direction of the spindle, the arm being configured, by one of the first grip member or the second grip member, to detach the subsequently-used tool from the tool pot disposed at the change position and attach the subsequently-used tool to the spindle and, by one other of the first grip member or the second grip member, to detach the previously-used tool from the spindle and attach the previously-used tool to the tool pot disposed at the change position, and
a grip interlocking mechanism that rotates a grip member on the magazine side of the first gripping member and the second gripping member in conjunction with a movement of the arm relative to the magazine to grip and release gripping of the tool, and rotates a grip member on the spindle side of the first gripping member and the second gripping member in conjunction with a movement of the arm relative to the spindle to grip and release gripping of the tool.

### Effects of the Invention

According to the present disclosure, it is possible to make it easier to overlap other operations of an arm with operations for gripping and releasing of the gripping of a tool.

### BRIEF DESCRIPTION OF THE DRAWINGS

FIG. 1 is a perspective view showing a tool changing device according to a first embodiment;

FIG. 2 is a front view showing the tool changing device;

FIG. 3 is a front view showing an arm and a pot interlocking mechanism;

FIG. 4 is a front view showing a tool pot at a storage angle and a tool;

FIG. 5 is a front view showing the tool pot at a change angle and the tool;

FIG. 6 is a perspective view showing the tool pot;

FIG. 7 is a side view showing a holding portion of the tool pot;

FIG. 8 is a perspective view showing an arm, an arm lifting device, and an arm pivoting device;

FIG. 9 is a plan cross-sectional view showing a grip portion of a grip member;

FIG. 10 is a front view showing the arm;

FIG. 11 is a bottom view showing the arm;

FIG. 12 is a plan view schematically showing the arm;

FIG. 13 is a front view schematically showing the arm;

FIG. 14 is a front view schematically showing a state in which the grip member is rotated to a release angle;

FIG. 15 is a front view schematically showing two grip members shifted in a second direction;

FIG. 16 is a front view schematically showing an initial state of a rotating operation of the grip member on the spindle side;

FIG. 17 is a front view schematically showing a subsequent rotating operation;

FIG. 18 is a front view schematically showing a subsequent rotating operation;

FIG. 19 is a front view schematically showing a subsequent rotating operation;

FIG. 20 is a front view schematically showing a subsequent rotating operation;

FIG. 21 is a front view showing an initial state of a tool change operation;

FIG. 22 is a front view showing a subsequent operation;

FIG. 23 is a front view showing a subsequent operation;

FIG. 24 is a front view showing a subsequent operation;

FIG. 25 is a front view showing a subsequent operation;

FIG. 26 is a front view showing a subsequent operation;

FIG. 27 is a front view showing a subsequent operation;

FIG. 28 is a front view showing a subsequent operation;

FIG. 29 is a front view showing a subsequent operation;

FIG. 30 is a front view showing a subsequent operation;

FIG. 31 is a front view showing a subsequent operation;

FIG. 32 is a front view showing a subsequent operation;

FIG. 33 is a front view schematically showing an initial state of a rotating operation according to the second embodiment;

FIG. 34 is a front view schematically showing a subsequent rotating operation;

FIG. 35 is a front view schematically showing a subsequent rotating operation;

FIG. 36 is a front view schematically showing a subsequent rotating operation;

FIG. 37 is a front view schematically showing a subsequent rotating operation;

FIG. 38 is a plan view schematically showing a tool changing device according to a third embodiment;

FIG. 39 is a plan view schematically showing a state in which an arm has pivoted to an access angle;

FIG. 40 is a configuration diagram showing a control system of a tool changing device;

FIG. 41 is a flowchart showing a procedure of tool change;

FIG. 42 is a configuration diagram showing a control system of a tool changing device according to a fourth embodiment;

FIG. 43 is a flowchart showing a procedure of controlling the moving speed of an arm; and

FIG. 44 is a flowchart showing another example of a procedure of controlling the moving speed of the arm.

### PREFERRED MODE FOR CARRYING OUT THE INVENTION

Hereinafter, embodiments of the present disclosure will be described with reference to the drawings. However, the present disclosure is not limited to the following embodiments in any way, and can be appropriately modified and implemented without departing from the gist of the present disclosure.

### First Embodiment

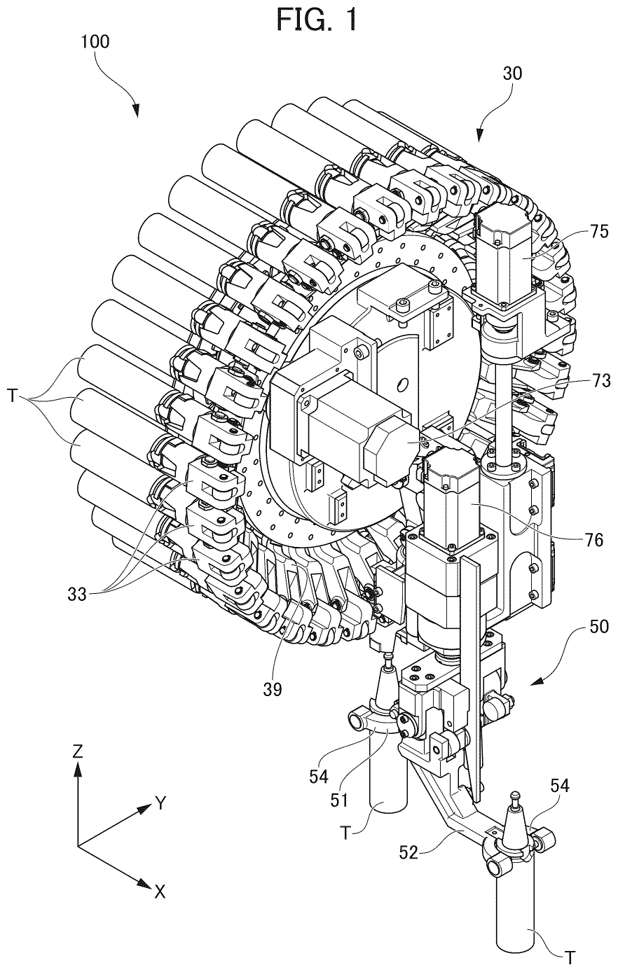

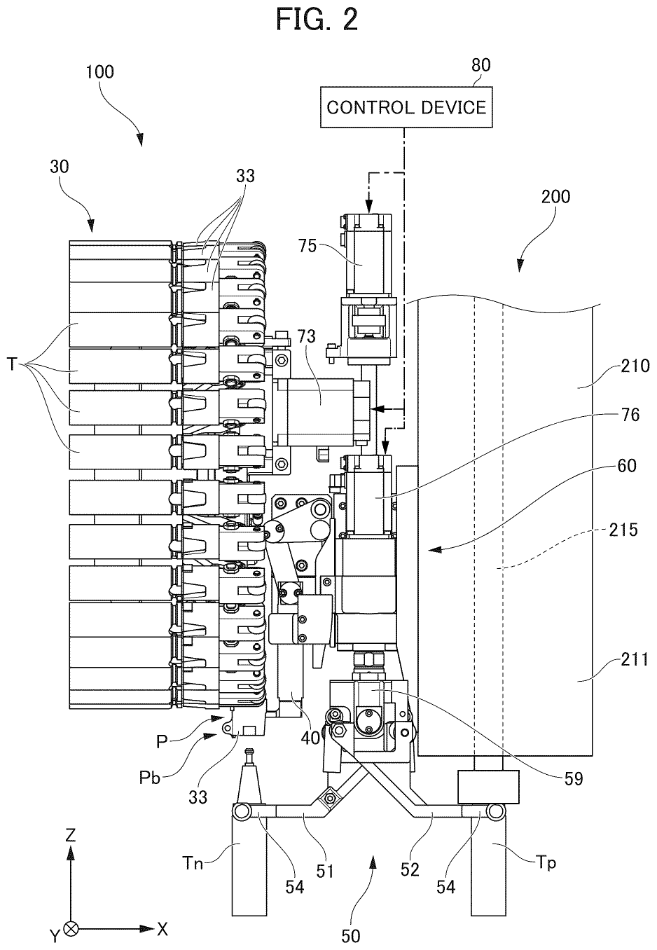

A tool changing device 100 shown in FIG. 1 is installed in a machine tool 200 as shown in FIG. 2. Hereinafter, three predetermined directions orthogonal to each other will be referred to as “left-right direction X”, “front-rear direction Y”, and “up-down direction Z”.

As shown in FIG. 2, the machine tool 200 includes a spindle assembly 210. The spindle assembly 210 includes a spindle 215 that is installed with its axial length direction in the up-down direction Z, and a housing 211 that covers the spindle 215, and is configured to be movable in the up-down direction Z.

As shown in FIG. 2, one of a plurality of tools T is attached to a lower end portion of the spindle 215. Hereinafter, the tool T attached to the spindle 215 up to now among the plurality of tools T is referred to as a “previously-used tool Tp”, and the tool T to be attached to the spindle 215 next among the plurality of tools T is referred to as a “subsequently-used tool In”.

The tool changing device 100 automatically detaches the previously-used tool Tp from the spindle 215 and attaches the subsequently-used tool In to the spindle 215. The tool changing device 100 includes a magazine 30, an arm 50, a pot interlocking mechanism 40, and a grip interlocking mechanism 60.

First, the magazine 30 will be described. As shown in FIG. 1, the magazine 30 includes a magazine body 39 and a plurality of tool pots 33.

The magazine body 39 is configured to be rotatable around the left-right direction X. The plurality of tool pots 33 are attached to the magazine body 39. By the rotation of the magazine body 39, one of the plurality of tool pots 33 is disposed at a “change position P” as the lowest standby position for tool change.

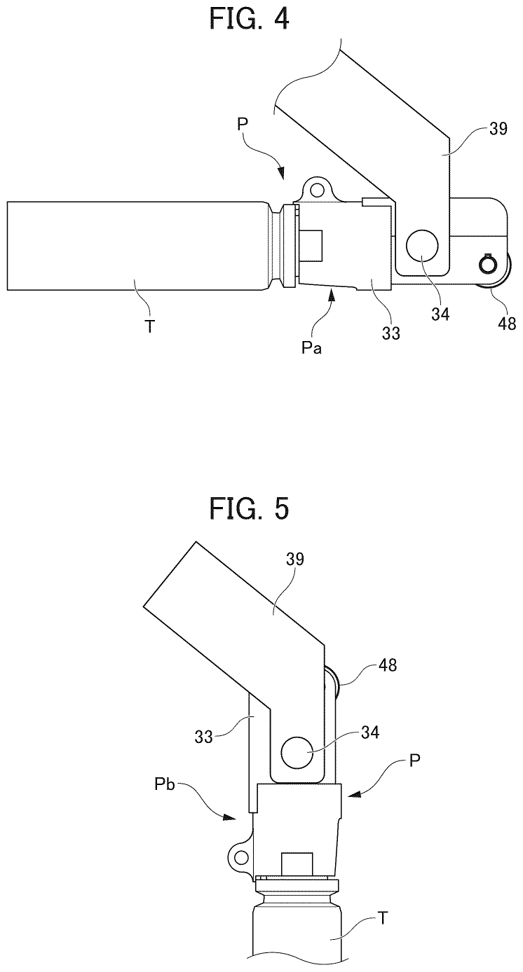

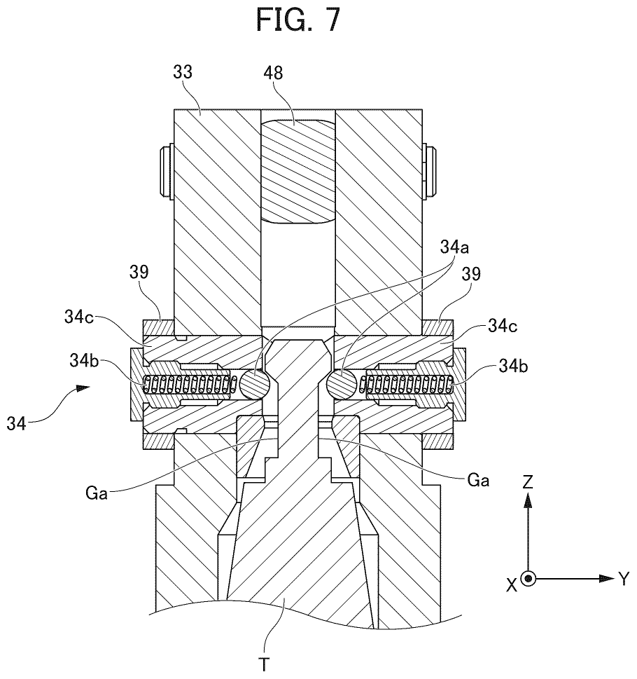

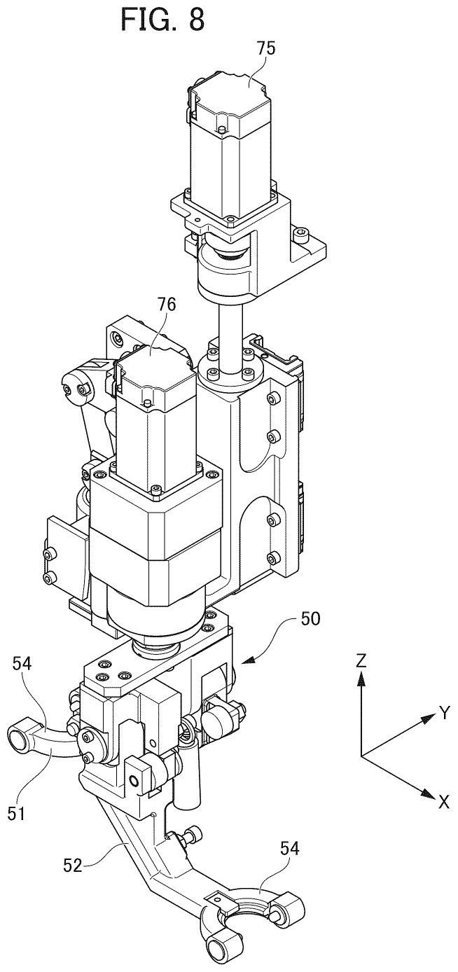

As shown in FIG. 7, each of the tool pots 33 has a holding portion 34 to which the tool T can be attached. The tool pot 33 is connected to the magazine body 39 by the holding portion 34 so as to be rotatable around the front-rear direction Y. That is, the holding portion 34 for attaching the tool T also serves as a rotational axis of the tool pot 33. By the holding portion 34, the tool pot 33 is configured to be rotatable between a storage angle Pa and a change angle Pb shown in FIG. 5 at the change position P shown in FIG. 4. As shown in FIG. 4, the storage angle Pa is an angle at which the tool pot 33 tips down in the left-right direction X. As shown in FIG. 5, the change angle Pb is an angle at which the tool pot 33 stands in the up-down direction Z.

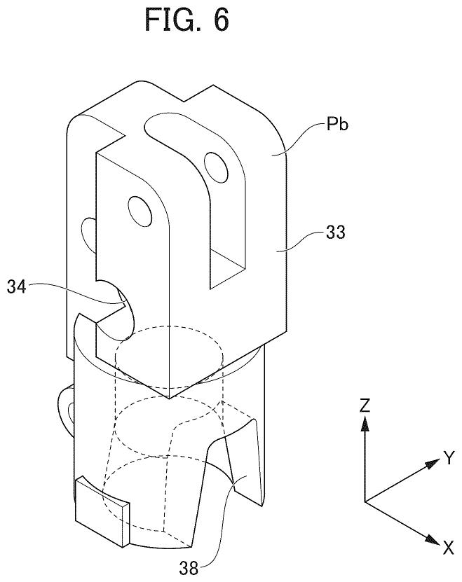

As shown in FIG. 6, each of the tool pots 33 has a bottomed cylindrical shape that opens downward in the state of the change angle Pb. In each of the tool pots 33, the tool T is attached by inserting the upper end portion of the tool T into the holding portion 34 from the lower side. Specifically, as shown in FIG. 7, the upper end portion of each of the tools T is provided with an annular upper engagement groove Ga extending around the up-down direction Z. The holding portion 34 includes a pair of clamping members 34a and 34a that can engage with the upper engagement groove Ga from both sides in the front-rear direction Y, and clamping springs 34b and 34b that bias the clamping members 34a and 34a toward each other. With these structures, the holding portion 34 is configured to be able to attach the tool T.

Each of the holding portions 34 has a pair of cylindrical storage members 34c and 34c for storing the clamping springs 34b and 34b, respectively. At least an outer peripheral portion of each of the storage members 34c is axially symmetric. Each of the tool pots 33 is rotatably attached to the magazine body 39 by the pair of storage members 34c and 34c. As shown in FIG. 6, a notch 38 is provided in an outer peripheral portion of the tool pot 33 on the side in a direction from the storage angle Pa toward the change angle Pb. The function of the notch 38 will be described later.

Hereinafter, as shown in FIG. 5, the tool pot 33 disposed at the change angle Pb at the change position P is simply referred to as a “tool pot 33 at the change angle Pb”. Further, detaching the subsequently-used tool In from the “holding portion 34 of the tool pot 33” is simply referred to as detaching the subsequently-used tool Tn from the “tool pot 33”. Further, attaching the previously-used tool Tp to the “holding portion 34 of the tool pot 33” is simply referred to as attaching the previously-used tool Tp to the “tool pot 33”.

Next, the arm 50 shown in FIG. 2 will be described. The arm 50 detaches the subsequently-used tool In from the tool pot 33 at the change angle Pb and attaches the subsequently-used tool In to the spindle 215, and detaches the previously-used tool Tp from the spindle 215 and attaches the previously-used tool Tp to the tool pot 33 at the change angle Pb.

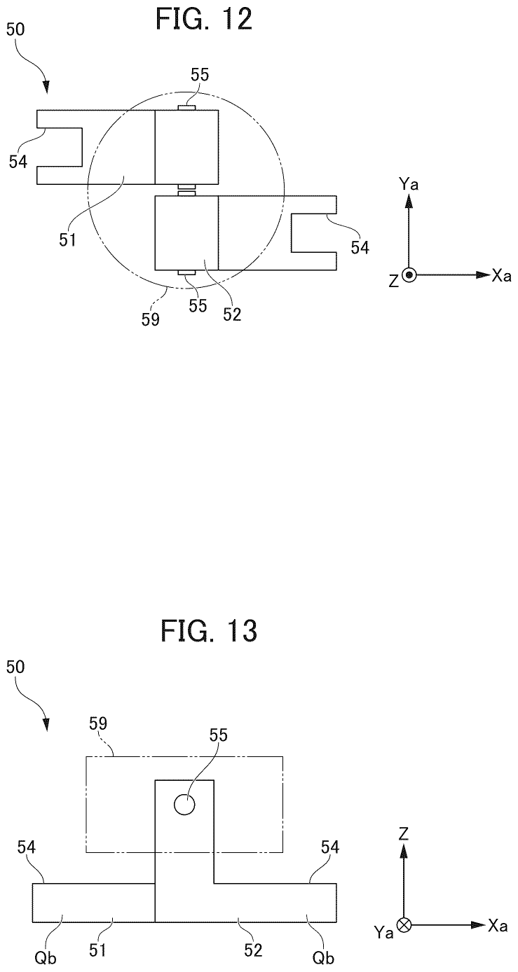

As schematically shown in FIG. 15, the arm 50 includes an arm main body 59, a first grip member 51, and a second grip member 52. Hereinafter, the first grip member 51 and the second grip member 52 will be collectively referred to as “grip members 51 and 52”. Hereinafter, as schematically shown in FIG. 12, a predetermined horizontal direction with respect to the arm main body 59 is referred to as a “first direction Ya”, and a horizontal direction orthogonal thereto is referred to as a “second direction Xa”. In the basic state of the arm 50, the first direction Ya is the front-rear direction Y, and the second direction Xa is the left-right direction X.

As schematically illustrated in FIG. 12, the first grip member 51 and the second grip member 52 are disposed so as to be shifted from each other in the first direction Ya when viewed in the up-down direction Z. As schematically shown in FIG. 13, when viewed in one side in the first direction Ya, the first grip member 51 has an inverted L-shape extending downward, and then toward one side in the second direction Xa, and the second grip member 52 has an L-shape extending downward, and then toward the other side in the second direction Xa. Upper end portions of the grip members 51 and 52 are attached to the arm main body 59 so as to be rotatable around the first direction Ya by respective shaft members 55. A grip portion 54 is provided at a tip portion as an end portion in the second direction Xa of each of the first grip member 51 and the second grip member 52.

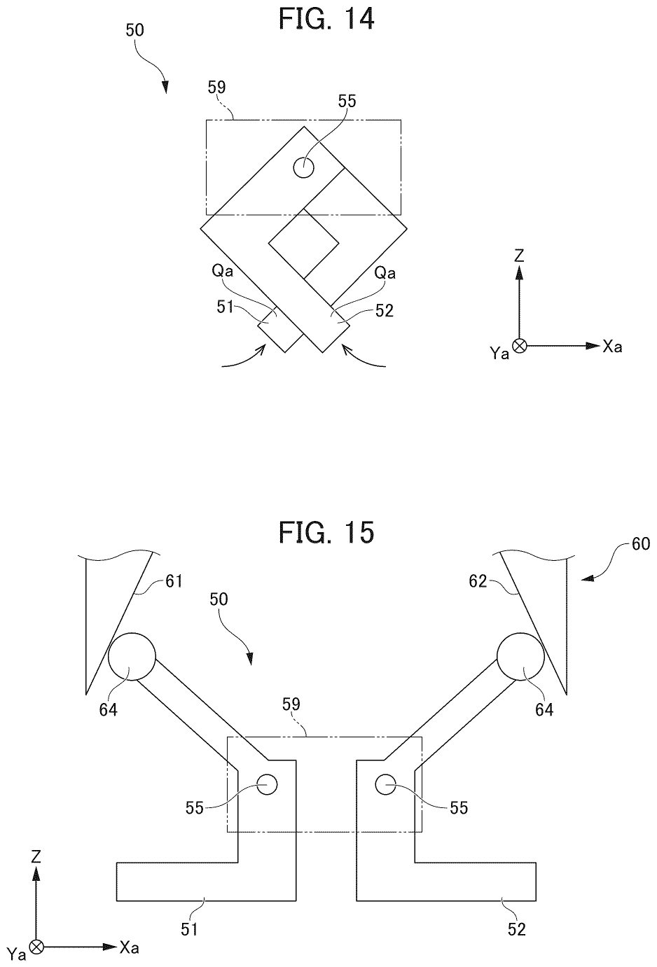

That is, as schematically shown in FIG. 12, when viewed in the up-down direction Z, the first grip member 51 and the second grip member 52 are supported so as to be rotatable around the first direction Ya with the grip portions 54 facing opposite sides in the second direction Xa. By the rotation, each of the grip members 51 and 52 is displaced at a grip angle Qb shown in FIG. 13 for gripping the tool T and a release angle Qa shown in FIG. 14 for releasing the gripping of the tool T. As shown in FIGS. 13 and 14, when viewed in the first direction Ya, the first grip member 51 and the second grip member 52 partially overlap each other.

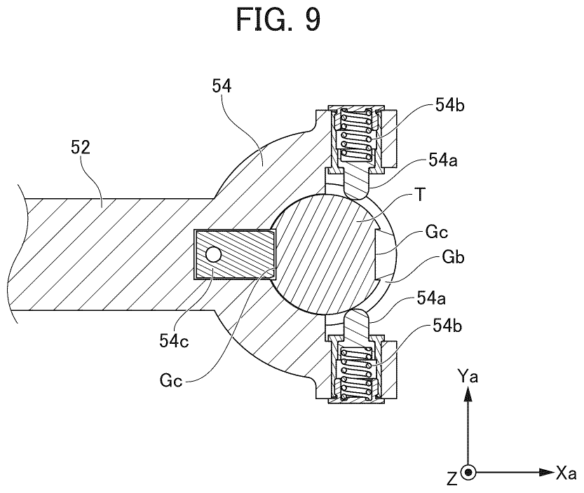

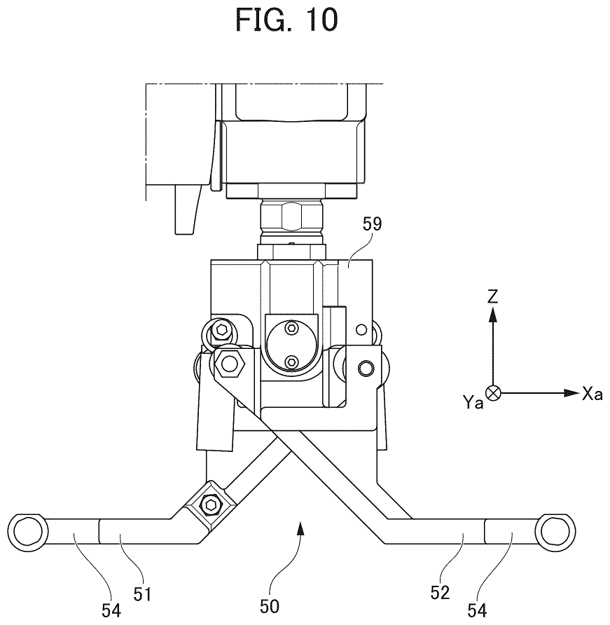

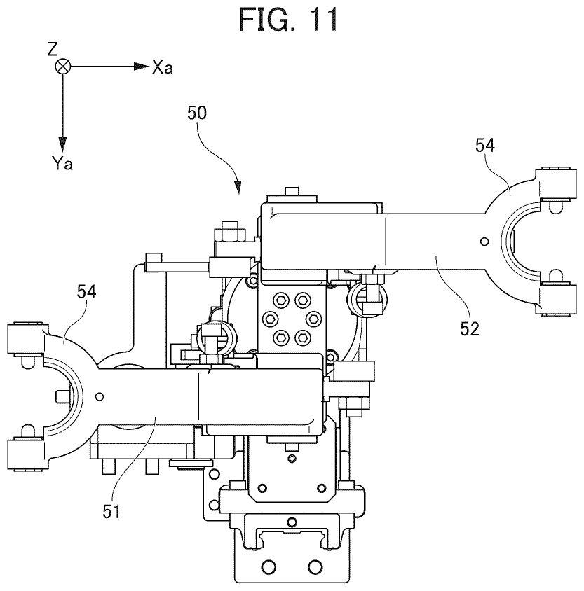

As shown in FIG. 9, the grip portion 54 has a U-shape that opens toward the tip end side, that is, toward one side in the second direction Xa, and is configured such that the upper portion of the tool T is insertable thereinto.

Specifically, an engagement recess portion Gc and a lower engagement groove Gb are provided below the upper engagement groove Ga in the upper portion of the tool T. The grip portion 54 includes an engagement protruding portion 54c, a pair of engagement members 54a and 54a, and a pair of engagement springs 54b and 54b. The engagement protruding portion 54c is provided on a portion of the grip portion 54 opposite to the tip end side, protrudes toward the tip end side, and is configured to be engageable with the engagement recess portion Gc. The pair of engagement members 54a and 54a are configured to be engageable with the lower engagement groove Gb from both sides in the first direction Ya on the tip side with respect to the center line of the tool T. The pair of engagement springs 54b and 54b bias the pair of engagement members 54a and 54a toward each other. With the above-described configuration, each of the grip portions 54 is configured to be capable of gripping the tool T at three points in location.

The arm main body 59 schematically shown in FIG. 13 is configured to be displaceable in the up-down direction Z and pivotable around the up-down direction Z. Hereinafter, among the first grip member 51 and the second grip member 52, the grip member of which the grip portion 54 is on the magazine 30 side is appropriately referred to as a “grip member 51 on the magazine 30 side” or a “grip member 52 on the magazine 30 side” with reference to the drawings. Among the first grip member 51 and the second grip member 52, the grip member having the grip portion 54 on the spindle 215 side is appropriately referred to as the “grip member 52 on the spindle 215 side” or the “grip member 51 on the spindle 215 side” with reference to the drawings.

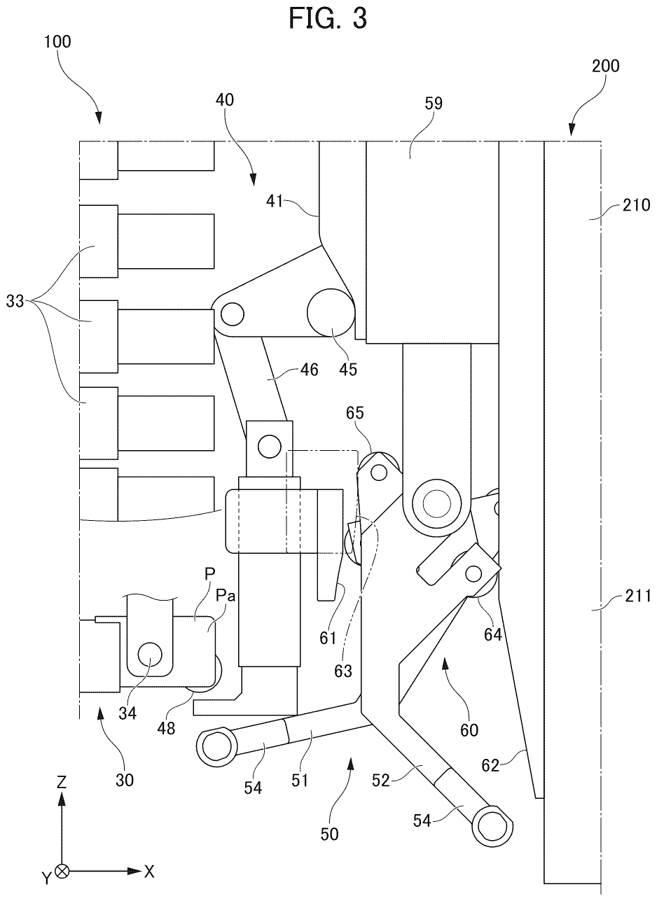

Next, the pot interlocking mechanism 40 shown in FIG. 3 will be described. The pot interlocking mechanism 40 rotates the tool pot 33 at the change position P from the storage angle Pa to the change angle Pb in conjunction with the lowering of the arm 50 relative to the magazine 30, and then rotates the tool pot 33 to the storage angle Pa again. In addition, the pot interlocking mechanism 40 rotates the tool pot 33 at the change position P from the storage angle Pa to the change angle Pb in conjunction with the raising of the arm 50 relative to the magazine 30, and then rotates the tool pot 33 to the storage angle Pa again.

The pot interlocking mechanism 40 includes an arm-side cam 41, a link roller 45, a link mechanism 46, and a pot roller 48. The link roller 45 is attached to an upper end portion of the link mechanism 46. When the link roller 45 is displaced toward the magazine 30 side, the lower end portion of the link mechanism 46 raises, and when the link roller 45 is displaced toward the arm 50 side, the lower end portion of the link mechanism 46 lowers. The arm-side cam 41 is provided at the arm main body 59 and is in contact with the link roller 45. The link roller 45 is biased toward the arm-side cam 41 by the weight of the link mechanism 46, a return spring (not shown) of the tool pot 33, other return springs, a weight, and the like.

The pot roller 48 is attached to a portion of each of the tool pots 33 separated from the holding portion 34, that is, a portion away from the rotational axis. When the lower end portion of the link mechanism 46 is raised, the pot roller 48 is pushed up by the lower end portion. As a result, the tool pot 33 rotates toward the change angle Pb. The above-described return spring (not shown) is attached to each of the tool pots 33, and is biased toward the storage angle Pa side by the biasing force of the return spring.

The arm-side cam 41 rotates the tool pot 33 via the link roller 45, the link mechanism 46, and the pot roller 48 by being displaced in the up-down direction Z with respect to the link roller 45 together with the arm 50.

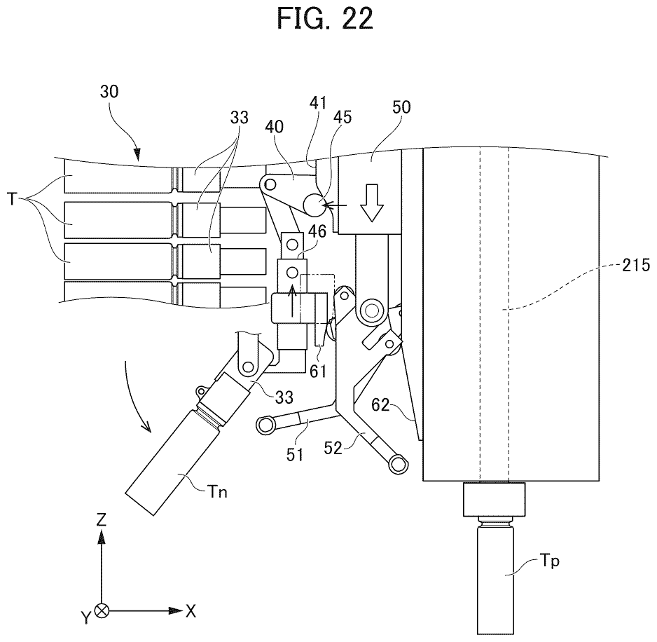

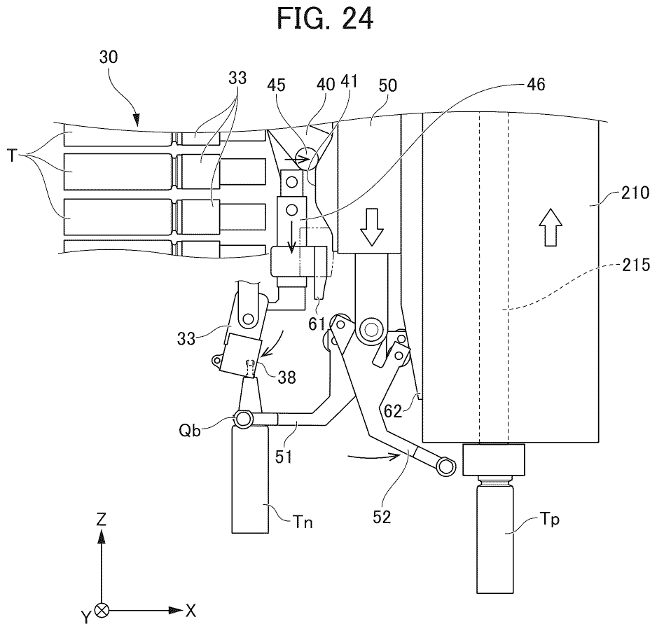

Specifically, as shown in FIG. 22, when the arm 50 is lowered relative to the magazine 30, the lower portion of the arm-side cam 41 displaces the link roller 45 toward the magazine 30 side to raise the lower end portion of the link mechanism 46, thereby rotating the tool pot 33 toward the change angle Pb side. As shown in FIG. 24, when the arm 50 is further lowered relative to the magazine 30, the upper portion of the arm-side cam 41 displaces the link roller 45 toward the arm 50 side to lower the lower end portion of the link mechanism 46, thereby returning the tool pot 33 to the storage angle Pa side.

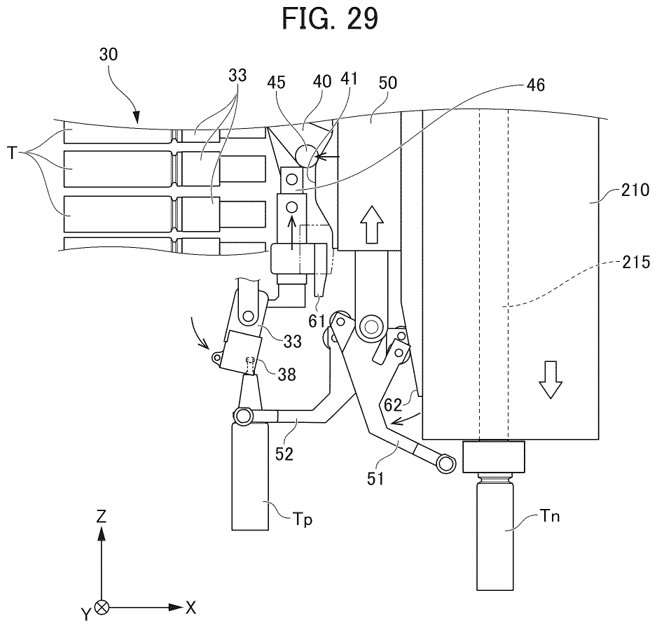

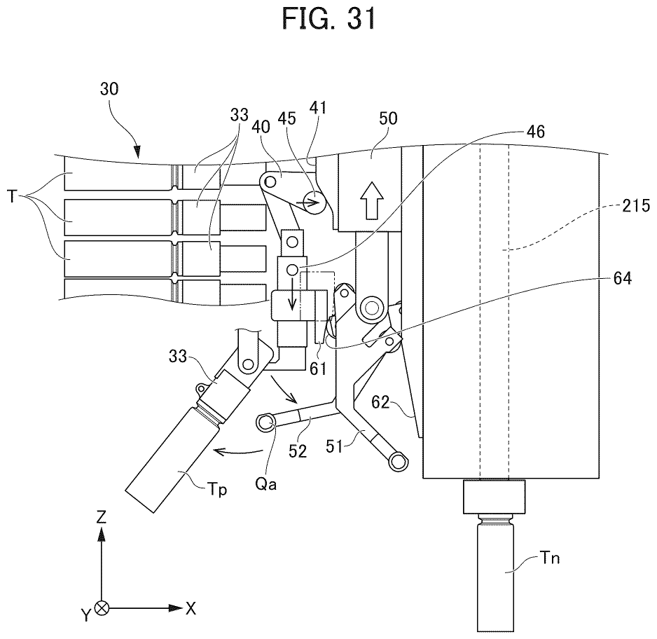

As shown in FIG. 29, when the arm 50 is raised relative to the magazine 30, the upper portion of the arm-side cam 41 displaces the link roller 45 toward the magazine 30 side to raise the lower end portion of the link mechanism 46, thereby rotating the tool pot 33 toward the change angle Pb. Further, as shown in FIG. 31, when the arm 50 is further raised relative to the magazine 30, the lower portion of the arm-side cam 41 displaces the link roller 45 toward the arm 50 side to lower the lower end portion of the link mechanism 46, thereby returning the tool pot 33 to the storage angle Pa side.

Next, the grip interlocking mechanism 60 shown in FIG. 3 will be described. The grip interlocking mechanism 60 rotates the grip member 51 on the magazine 30 side toward the grip angle Qb side in conjunction with the lowering of the arm 50 relative to the magazine 30. In addition, the grip interlocking mechanism 60 rotates the grip member 52 on the spindle side toward the grip angle Qb side in conjunction with the lowering of the arm 50 relative to the spindle 215. In addition, the grip interlocking mechanism 60 rotates the grip member 51 on the spindle side toward the release angle Qa side in conjunction with the raising of the arm 50 relative to the spindle 215. In addition, the grip interlocking mechanism 60 rotates the grip member 52 on the magazine 30 side toward the release angle Qa side in conjunction with the raising of the arm 50 relative to the magazine 30.

As schematically shown in FIG. 15, the grip interlocking mechanism 60 includes a magazine-side cam 61, a spindle-side cam 62, and arm rollers 64. Although FIG. 15 schematically shows the two grip members 51 and 52 shifted in the second direction Xa for better visibility, practically, as described above, the two grip members 51 and 52 partially overlap each other when viewed in the first direction Ya. However, when there is margin of space in the second direction Xa, the two grip members 51 and 52 may be actually disposed so as to be shifted in the second direction Xa as shown in FIG. 15.

The magazine-side cam 61 is attached to a frame, a housing, or the like of the tool changing device 100. The spindle-side cam 62 is attached to the frame, the housing 211, or the like of the spindle assembly 210. One arm roller 64 is attached to each of the grip members 51 and 52. Therefore, the arm roller 64 moves relative to the magazine-side cam 61 and the spindle-side cam 62 in the up-down direction Z together with the arm 50. Each of the grip members 51 and 52 is biased toward the release angle Qa side by a return spring, a weight, the weight thereof, or the like. Therefore, the arm roller 64 of the grip member 51 on the magazine 30 side is biased by the magazine side cam 61, and the arm roller 64 of the grip member 52 on the spindle 215 side is biased by the spindle-side cam 62.

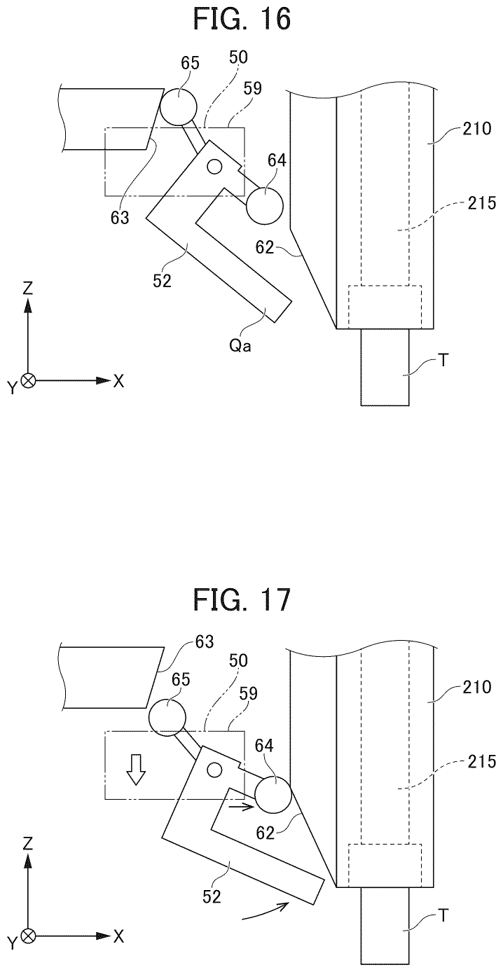

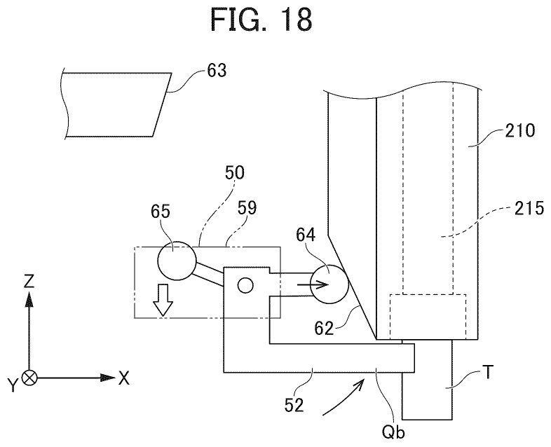

As schematically shown in FIG. 16, the grip interlocking mechanism 60 further includes a separation cam 63 and a separation roller 65. The separation cam 63 is provided at a position further away from the spindle 215 than the spindle-side cam 62, and specifically, is attached to a frame, a housing, or the like of the tool changing device 100. One separation roller 65 is attached to each of the grip members 51 and 52. The separation roller 65 moves relative to the separation cam 63 in the up-down direction Z together with the arm 50.

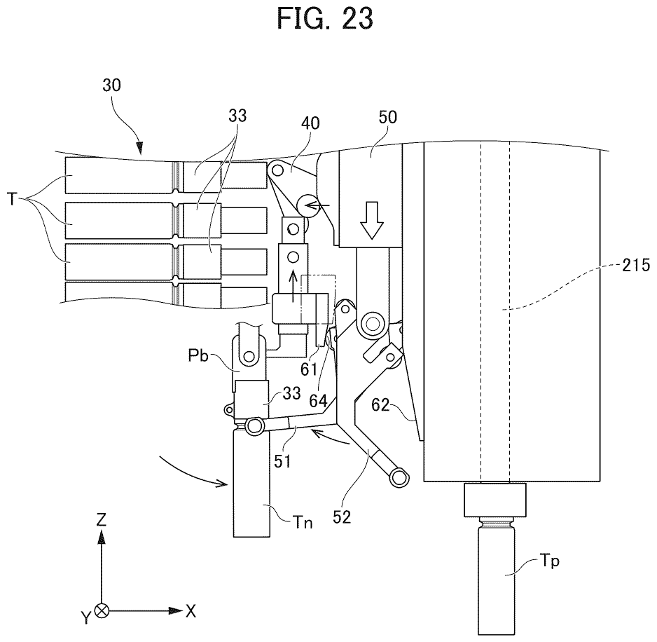

As shown in FIG. 23, the arm roller 64 is displaced toward the magazine 30 side according to the profile of the magazine-side cam 61 in conjunction with the lowering of the arm 50 relative to the magazine 30, so that the grip member 51 on the magazine 30 side rotates toward the grip angle Qb side. Further, as shown in FIG. 31, the arm roller 64 is displaced toward the arm 50 side according to the profile of the magazine-side cam 61 in conjunction with the raising of the arm 50 relative to the magazine 30, so that the grip member 51 on the magazine 30 side rotates toward the release angle Qa side.

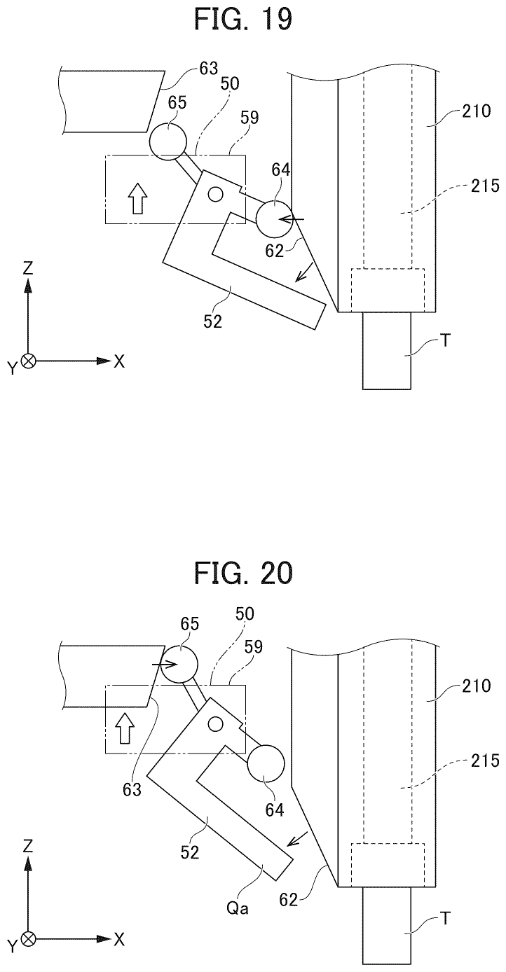

Further, as schematically shown in FIG. 17, the arm roller 64 is displaced toward the spindle 215 side according to the profile of the spindle-side cam 62 in conjunction with the lowering of the arm 50 relative to the spindle 215, so that the grip member 52 on the spindle 215 side rotates toward the grip angle Qb side. Further, as schematically shown in FIG. 19, the arm roller 64 is displaced toward the arm 50 side according to the profile of the spindle-side cam 62 in conjunction with the raising of the arm 50 to the predetermined position relative to the spindle 215, so that the grip member 52 on the spindle 215 side rotates toward the release angle Qa side.

As shown in FIG. 20, the separation roller 65 is displaced toward the arm 50 side according to the profile of the separation cam 63 in conjunction with further raising of the arm 50 from the predetermined position relative to the spindle 215, so that the grip member 52 on the spindle 215 side further rotates toward the release angle Qa side. By this rotation, the arm roller 64 is separated from the spindle-side cam 62.

As shown in FIG. 2, the tool changing device 100 further includes a magazine rotating device 73, an arm lifting device 75, an arm pivoting device 76, and a control device 80. The magazine rotating device 73 rotates the magazine 30 around the left-right direction X. The arm lifting device 75 moves the arm 50 in the up-down direction Z. The arm pivoting device 76 pivots the arm 50 around the up-down direction Z. Each of the magazine rotating device 73, the arm lifting device 75, and the arm pivoting device 76 is an actuator such as a motor. In the tool changing device 100, the control device 80 controls each device including these actuators.

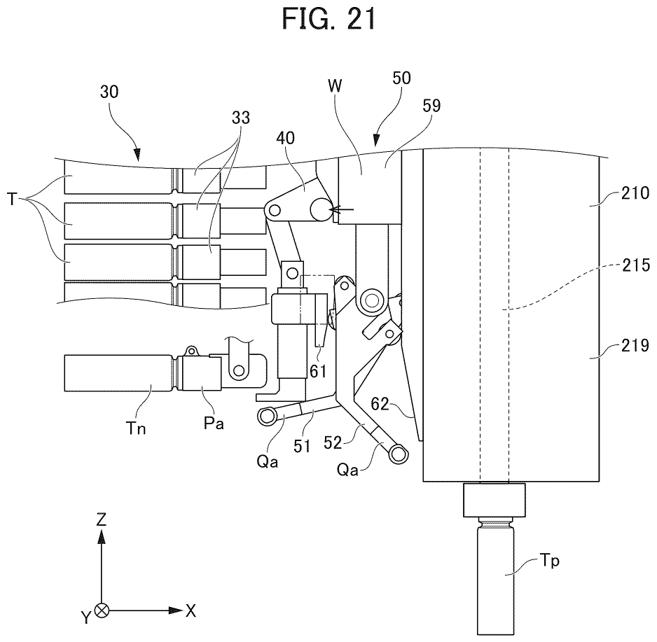

Next, with reference to FIGS. 21 to 32, a specific procedure of tool change based on control by the control device 80 will be described. As shown in FIG. 21, in the initial state, the arm 50 is disposed at the “standby position W” as the uppermost portion in the stroke in the up-down direction Z. At this time, the grip members 51 and 52 are disposed at the release angle Qa.

From this state, as shown in FIG. 22, the arm 50 is lowered. In conjunction with the lowering, the tool pot 33 at the change position P rotates toward the change angle Pb side, and the grip member 51 on the magazine 30 side rotates toward the grip angle Qb side. Then, as shown in FIG. 23, the tool pot 33 at the change position P is disposed at the change angle Pb, the grip member 51 on the magazine 30 side is disposed at the grip angle Qb, and the grip member 51 grips the upper portion of the subsequently-used tool Tn of the tool pot 33.

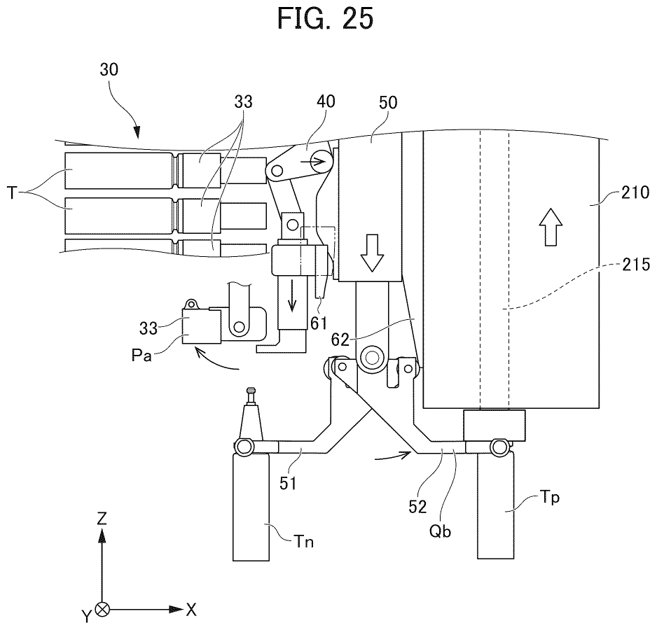

From this state, as shown in FIG. 24, when the arm 50 is further lowered, the grip member 51 on the magazine 30 side detaches the subsequently-used tool In from the tool pot 33 at the change angle Pb. Thereafter, in conjunction with further lowering of the arm 50, the tool pot 33 at the change position P rotates toward the storage angle Pa side. At this time, the upper portion of the subsequently-used tool In passes through the notch 38. Thereafter, as shown in FIG. 25, when the tool pot 33 rotates to the storage angle Pa, the magazine 30 starts rotating, and starts an operation of moving a desired tool pot 33 for storing the previously-used tool Tp to the change angle Pb.

In parallel with these operations, as shown in FIG. 25, when the arm 50 is lowered and the spindle assembly 210 is raised, the arm 50 is lowered relative to the spindle 215. In conjunction with the relative lowering, the grip member 52 on the spindle 215 side rotates toward the grip angle Qb side, and grips the upper portion of the previously-used tool Tp of the spindle 215.

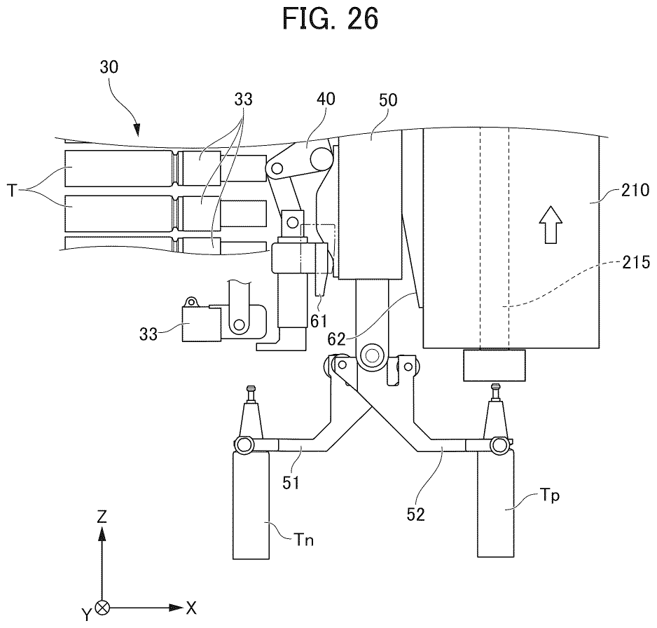

From this state, as shown in FIG. 26, when the spindle assembly 210 is further raised, that is, when the arm 50 is further lowered relative to the spindle 215, the grip member 52 on the spindle side detaches the previously-used tool Tp from the spindle 215.

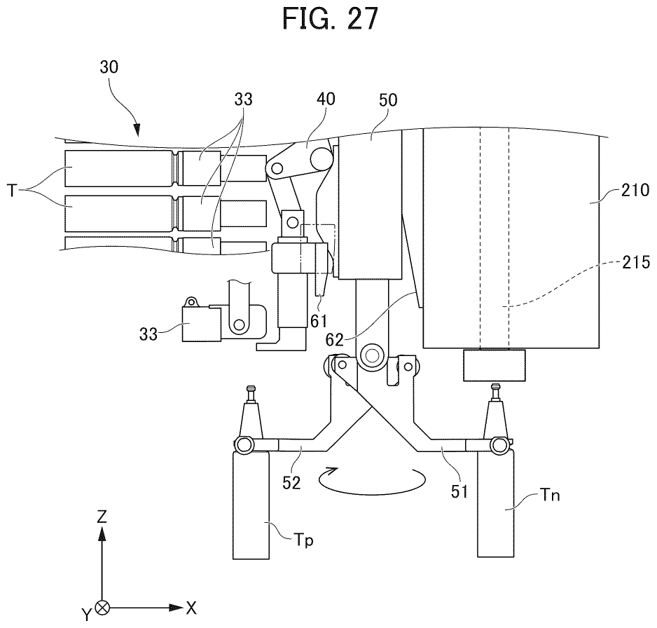

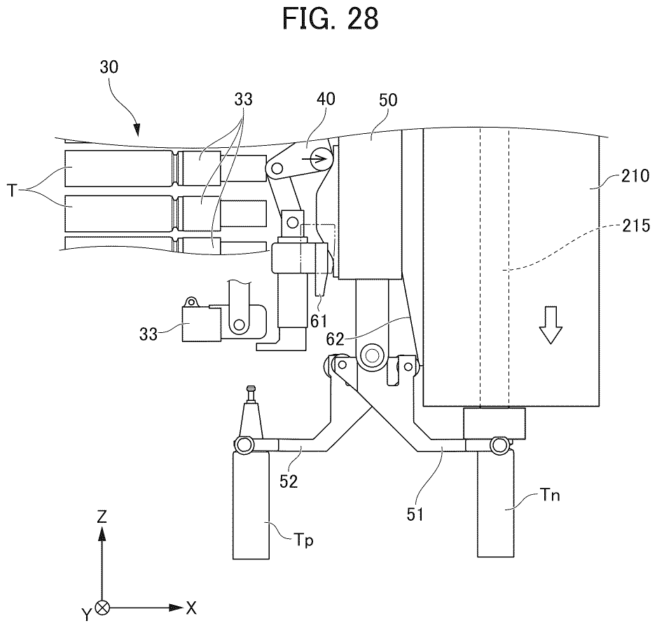

Next, as shown in FIG. 27, the arm 50 pivots 180° around the up-down direction Z. By the pivoting, the grip member 51 on the magazine 30 side and the grip member 52 on the spindle 215 side are interchanged with each other. As a result, the previously-used tool Tp is located on the magazine 30 side, and the subsequently-used tool Tn is located on the spindle 215 side. Thereafter, as shown in FIG. 28, when the spindle assembly 210 is lowered, that is, when the arm 50 is raised relative to the spindle 215, the grip member 51 on the spindle 215 side attaches the subsequently-used tool Tn to the spindle 215.

Thereafter, as shown in FIG. 29, as the spindle assembly 210 is further lowered and the arm 50 is raised, the arm 50 is further raised relative to the spindle 215. In conjunction with the relative raising, the grip member 51 on the spindle 215 side rotates toward the release angle Qa side to release the gripping of the subsequently-used tool Tn.

Further, as the arm 50 is raised at this time, the arm 50 is raised relative to the magazine 30 as shown in FIG. 29. In conjunction with the relative raising, the tool pot 33 at the change position P rotates toward the change angle Pb. At this time, the operation of moving the desired tool pot 33 to the change position P has already been completed. Therefore, the desired tool pot 33 is disposed at the change position P. When the tool pot 33 rotates toward the change angle Pb side, the upper portion of the previously-used tool Tp passes through the notch 38 of the rotating tool pot 33.

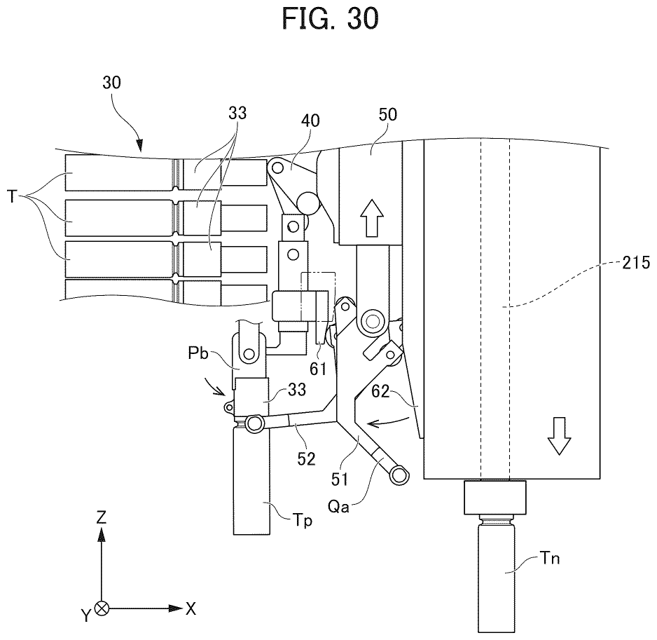

Then, as shown in FIG. 30, the tool pot 33 at the change position P is disposed at the change angle Pb, and the grip member 52 on the magazine 30 side attaches the previously used tool Tp to the tool pot 33.

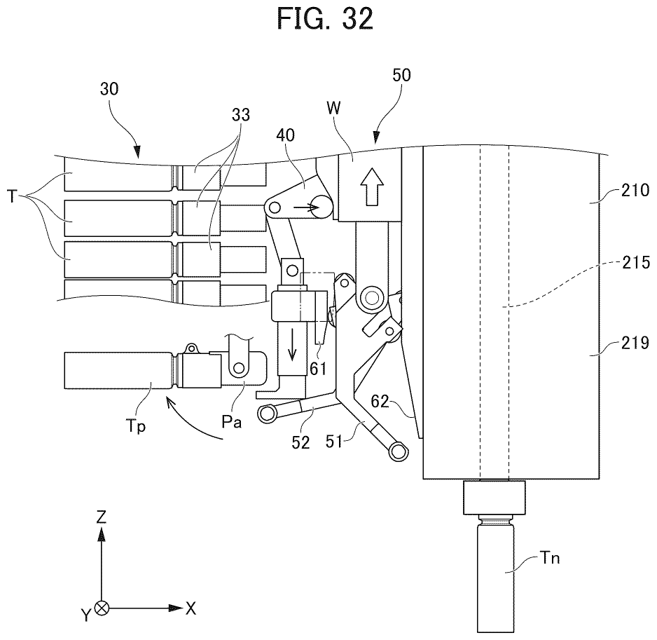

Thereafter, as shown in FIG. 31, in conjunction with the arm 50 being further raised, the tool pot 33 at the change position P rotates toward the storage angle Pa side and the grip member 51 on the magazine 30 side rotates toward the release angle Qa side. By these rotations, the grip member 52 on the magazine 30 side releases the gripping of the previously-used tool Tp. Thereafter, as shown in FIG. 32, the tool pot 33 at the change position P returns to the storage angle Pa in conjunction with the arm 50 being raised to the original uppermost standby position W.

Hereinafter, the configuration and effects of the present embodiment will be summarized.

As shown in FIG. 7, the tool pot 33 is rotatably attached to the magazine body 39 by the holding portion 34 for attaching the tool T, and the holding portion 34 also serves as a rotational axis of the tool pot 33. Therefore, the structure of the tool pot 33 is simpler than in the case where the holding portion 34 and the rotational axis are separately provided.

The pot interlocking mechanism 40 shown in FIG. 3 rotates the tool pot 33 at the change position P in conjunction with the movement of the arm 50 relative to the magazine 30. Therefore, it is possible to rotate the tool pot 33 to the change angle Pb and the storage angle Pa without a drive source dedicated to the rotation of the tool pot 33.

Further, the pot interlocking mechanism 40 rotates the tool pot 33 from the storage angle Pa to the change angle Pb in conjunction with the lowering of the arm 50 to the predetermined position relative to the magazine 30.

Thereafter, the pot interlocking mechanism 40 rotates the tool pot 33 from the change angle Pb to the storage angle Pa in conjunction with further lowering of the arm 50 from the predetermined position relative to the magazine 30. Therefore, it is possible to perform a series of operations of rotating the tool pot 33 from the storage angle Pa to the change angle Pb in conjunction with the lowering of the arm 50 relative to the magazine 30, and returning to the storage angle Pa. Similarly, it is possible to perform the series of operations in conjunction with the raising of the arm 50 relative to the magazine 30.

As shown in FIG. 6, the notch 38 is provided in an outer peripheral portion of the tool pot 33 in a direction from the storage angle Pa toward the change angle Pb. During the movement of the arm 50 relative to the magazine 30, the tool pot 33 rotates, and the upper portion of the tool T passes through the notch 38. As a result, it is possible that the movement of the arm 50 relative to the magazine 30 and the rotating operation of the tool pot 33 largely overlap each other, such that the cycle time of tool change is shortened.

Further, when the tool pot 33 is rotated in conjunction with the movement of the arm 50 relative to the magazine 30 in the up-down direction Z, even if the stroke of the relative movement of the arm 50 in the up-down direction Z is small, it is possible to secure a sufficiently large stroke of the rotation of the tool pot 33 by overlapping largely as described above. Therefore, it is possible to suppress the need for the stroke of relative movement of the arm 50 relative to the magazine 30 in the up-down direction Z.

As shown in FIGS. 13 and 14, the first grip member 51 and the second grip member 52 are configured to be rotatable around the front-rear direction Y independently of each other, and perform gripping and releasing of the tool T by rotating independently of each other. Therefore, as compared with a case where the tool T can be gripped and released only at the same timing, it is possible to facilitate other operations in parallel with the operation by the arm 50.

Specifically, as shown in FIG. 24, the control unit 80 allows the grip member 51 on the magazine 30 side to detach the subsequently-used tool In from the tool pot 33 at the change position P, and then allows the grip member 52 on the spindle 215 side to detach the previously-used tool Tp from the spindle 215. In parallel with the operation of detaching the previously-used tool Tp, the magazine 30 is rotated to advance the operation of arranging the desired tool pot 33 for storing the previously-used tool Tp at the change position P. As a result, it is possible to store the previously-used tool Tp quickly in the desired tool pot 33.

As schematically illustrated in FIG. 12, when viewed in the up-down direction Z, the first and second grip members 51 and 52 are disposed so as to be shifted from each other in the first direction Ya and are disposed so that the grip portions 54 face opposite sides to each other in the second direction Xa. Therefore, as shown in FIG. 13, when viewed in the first direction Ya, the first and second grip members 51 and 52 can be disposed so as to partially overlap each other. Thus, it is possible to compactly assemble the arm 50 in the second direction Xa while avoiding interference between the first grip member 51 and the second grip member 52.

If the gripping portion 54 is pressed against the tool T to grip the tool T or is pulled away from the tool T to release the gripping of the tool T by slightly pivoting the arm 50 shown in FIG. 2 around the up-down direction Z, the following problem arises. That is, it is necessary to move the arm 50 in the up-down direction Z relative to the magazine 30 and the spindle 215 after firmly stopping the pivoting of the arm 50. Therefore, it is difficult to cause the acceleration/deceleration operation for gripping and releasing the gripping of the tool T to overlap other operations such as raising and lowering of the arm 50. Therefore, it is difficult to shorten the cycle time of tool change.

In this regard, in the present embodiment, as shown in FIG. 13, each of the grip members 51 and 52 is configured to be rotatable around the first direction Ya orthogonal to the axial length direction of the spindle 215, and in addition, the grip interlocking mechanism 60 schematically shown in FIG. 15 is provided. The grip interlocking mechanism 60 rotates the grip member 51 on the magazine 30 side in conjunction with the movement of the arm 50 relative to the magazine 30 in the up-down direction Z to grip and release the gripping of the tool T. In addition, the grip interlocking mechanism 60 rotates the grip member 52 on the spindle 215 side in conjunction with the movement of the arm 50 relative to the spindle 215 in the up-down direction Z to grip and release the gripping of the tool T. Therefore, it is not necessary to pivot the arm 50 around the up-down direction Z in order to grip or release the gripping of the tool T. Therefore, it is not necessary to move the arm 50 relative to the magazine 30 and the spindle 215 in the up-down direction Z after firmly stopping the pivoting.

Therefore, it is possible to cause other operations of the arm 50, such as raising and lowering of the arm 50, to overlap with the rotating operations of the grip members 51 and 52, that is, the acceleration and deceleration operations for gripping and releasing the gripping of the tool T. Therefore, it is possible to shorten the cycle time of tool change.

As schematically shown in FIG. 16, the grip interlocking mechanism 60 includes the spindle-side cam 62, the arm roller 64, the separation cam 63, and the separation roller 65. As schematically shown in FIG. 19, when the arm 50 is raised to a predetermined position relative to the spindle 215, the arm roller 64 is displaced according to the profile of the spindle-side cam 62 to rotate the grip member 52 toward the release angle Qa side. As schematically shown in FIG. 20, when the arm 50 is further raised from the predetermined position relative to the spindle 215, the separation roller 65 is displaced according to the profile of the separation cam 63 to further rotate the grip member 52 toward the release angle Qa. As a result, the arm roller 64 is separated from the spindle-side cam 62. Therefore, when the grip member 52 is positioned at the release angle Qa, the spindle-side cam 62 does not receive any force from the arm roller 64. At this time, although the separation roller 65 is in contact with the separation cam 63, since the separation cam 63 is further away from the spindle 215 than the spindle-side cam 62, an external force is less likely to be applied to the spindle 215 than in the case where the arm roller 64 is in contact with the spindle-side cam 62. Therefore, it is possible to suppress the external force applied to the spindle 215 during the machining by the spindle 215, and it is possible to suppress the adverse effect of the external force on the machining accuracy and the machined surface quality.

### Second Embodiment

Next, a second embodiment will be described with reference to FIGS. 33 to 37. In addition, the following embodiments including the present embodiment will be described based on predetermined embodiments that have been described earlier, with a focus on points that differ therefrom, and descriptions of points that are the same as or similar to those of the embodiment based thereon will be omitted as appropriate. The present embodiment will be described based on the first embodiment.

In the present embodiment, as shown in FIG. 33, the grip interlocking mechanism 60 includes a spring 67, a grip-side stopper 68a, a release-side stopper 68b, and a rotation mechanism 69. In the present embodiment, only the grip member 52 will be described, but the same applies to the grip member 51.

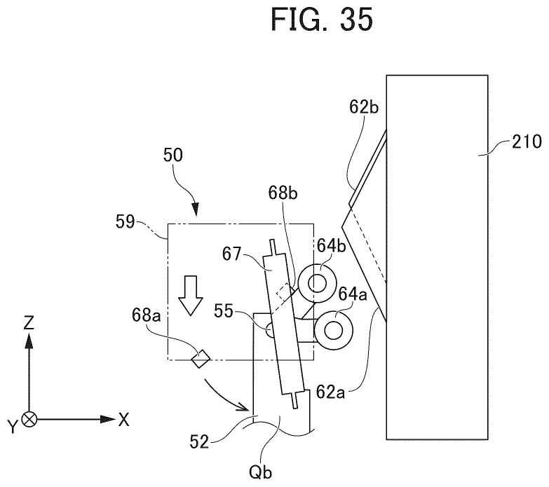

One end of the spring 67 is attached to the arm main body 59 and the other end thereof is attached to the grip member 52, and a change from a natural state is maximized at a predetermined intermediate point between the release angle Qa and the grip angle Qb of the grip member 52. Therefore, as shown in FIG. 35, in a state where the grip member 52 is closer to the grip angle Qb side than the intermediate point, the spring 67 biases the grip member 52 toward the grip angle Qb side. The grip-side stopper 68b restricts the gripping member 52 from further rotating when rotating to the gripping angle Qb. On the other hand, as shown in FIG. 37, in a state where the grip member 52 is closer to the release angle Qa side than the intermediate point, the spring 67 biases the grip member 52 toward the release angle Qa side. The release-side stopper 68a restricts the grip member 52 from further rotating when rotating to the release angle Qa.

Specifically, in the present embodiment, the spring 67 is a pull spring and has a maximum length at the intermediate point. However, in place of this, for example, the spring 67 may be a push spring so that the length reaches a minimum at the intermediate point.

As shown in FIG. 33, the grip interlocking mechanism 60 includes a gripping cam 62b and a releasing cam 62a arranged in the first direction Ya, in place of the spindle-side cam 62 in the first embodiment. The grip interlocking mechanism 60 includes a gripping roller 64b and a releasing roller 64a arranged side by side in the front-rear direction Y, in place of the arm roller 64 and the separation roller 65 described in the first embodiment. The rotation mechanism 69 includes the gripping cam 62b, the releasing cam 62a, the gripping roller 64b, and the releasing roller 64a.

The gripping roller 64b and the releasing roller 64a are attached to the grip member 52, and move relative to the gripping cam 62b and the releasing cam 62a in the up-down direction Z together with the arm 50.

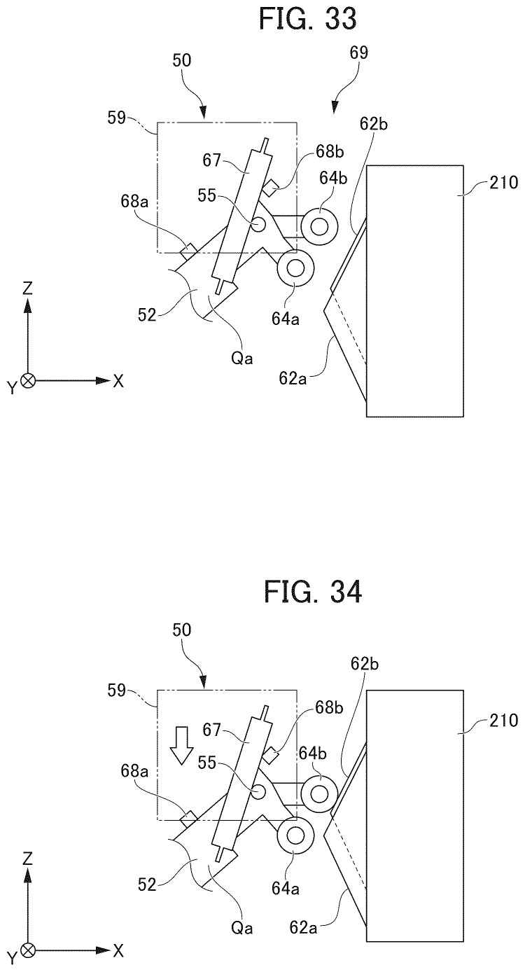

As shown in FIG. 34, when the arm 50 is lowered relative to the spindle 215, the gripping roller 64b comes into contact with the gripping cam 62b to rotate the grip member 52 toward the grip angle Qb side from the above-described intermediate point. Thereafter, the grip member 52 is rotated to the grip angle Qb by the biasing force of the spring 67. At this time, as shown in FIG. 35, the grip member 52 is biased to the gripping-side stopper 68b, and the gripping roller 64b and the releasing roller 64a are separated from the gripping cam 62b and the releasing cam 62a, respectively.

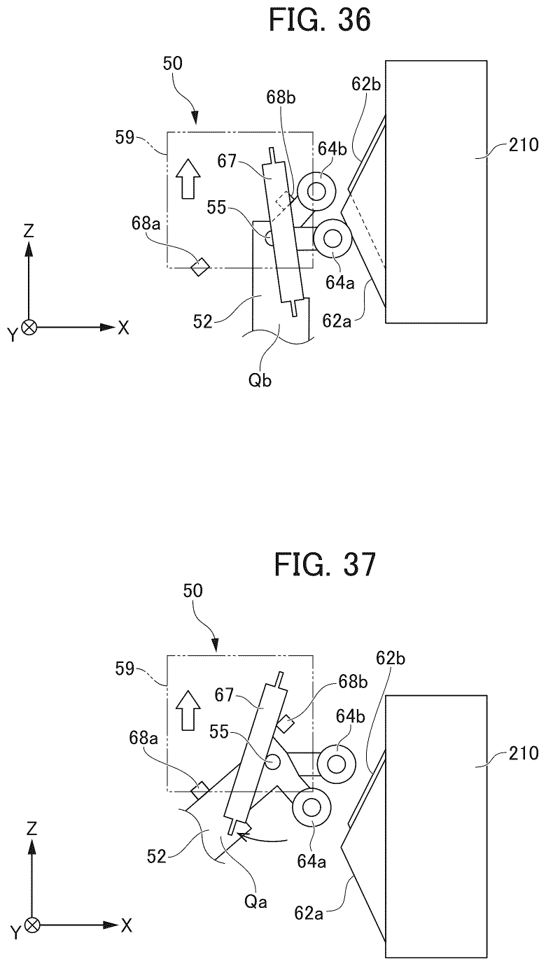

As shown in FIG. 36, when the arm 50 is raised relative to the spindle 215, the releasing roller 64a comes into contact with the releasing cam 62a to rotate the grip member 52 more toward the release angle Qa side from the intermediate point. Thereafter, the grip member 52 is rotated to the release angle Qa by the biasing force of the spring 67. At this time, as shown in FIG. 37, the grip member 52 is biased to the release-side stopper 68a, and the gripping roller 64b and the releasing roller 64a are separated from the gripping cam 62b and the releasing cam 62a, respectively.

The grip interlocking mechanism 60 also has a gripping cam and a releasing cam similar to the gripping cam 62b and the releasing cam 62a described above, in place of the magazine-side cam 61 described in the first embodiment, on the magazine 30 side. However, for example, the gripping cam on the magazine 30 side may be referred to as a “magazine-side cam”, and the gripping cam 62b on the spindle 215 side may be referred to as a “spindle-side cam”. The gripping roller may be referred to as an “arm roller”. That is, also in the present embodiment, similarly to the case schematically shown in FIG. 15, a configuration is established in which the “arm roller” of the grip member 51 on the magazine 30 side comes into contact with the “magazine-side cam”, and the “arm roller” of the grip member 52 on the spindle 215 side comes into contact with the “spindle-side cam”.

As described above, according to the present embodiment, as shown in FIG. 37, when the grip member 52 is disposed at the release angle Qa, the grip member 52 is biased to the release-side stopper 68b. Therefore, the gripping cam 62b and the releasing cam 62a do not receive force from the gripping roller 64b and the releasing roller 64a. Therefore, it is possible to suppress the external force applied to the spindle 215 during the machining by the spindle 215, and it is possible to suppress the adverse effect of the external force on the machining accuracy and the machining surface quality.

### Third Embodiment

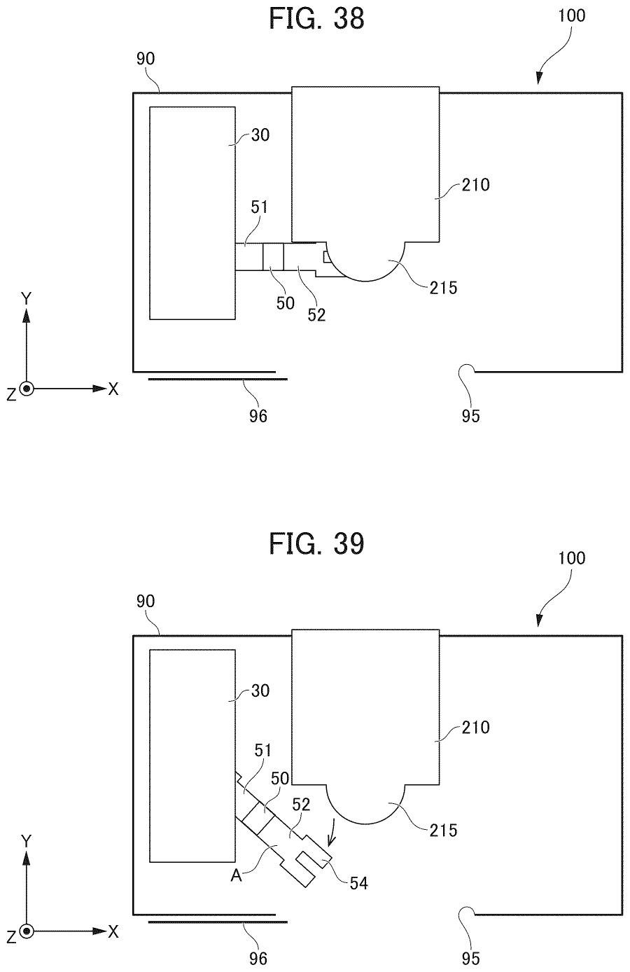

Next, a third embodiment will be described based on the first embodiment with reference to FIGS. 38 to 41. However, the present embodiment may be implemented based on the second embodiment. As schematically shown in FIG. 38, the tool changing device 100 of the present embodiment includes a housing 90 in which an opening 95 is provided in the front surface. The magazine 30, the pot interlocking mechanism 40, the arm 50, the grip interlocking mechanism 60, the spindle assembly 210, and the like are stored in the housing 90. A door 96 is attached to the opening 95.

Hereinafter, an operation for taking in a tool T different from all of the tools including the tools T attached to the tool pots 33 and the tool T attached to the spindle 215 into the tool changing device 100 will be referred to as “loading”. Further, the operation of taking out one among all of these tools to the outside of the tool changing device 100 is referred to as “unloading”. In the following description, performing the “loading” and the “unloading” using the grip member 52 is described. However, the “loading” and the “unloading” may be performed using the grip member 51.

As schematically shown in FIG. 39, the control device 80 pivots the arm 50 to a predetermined access angle A at the time of the “loading”, and arranges the grip member 52 that has not gripped any tool T at a position closer to the opening 95 than the position before the pivoting. On the other hand, at the time of the “unloading”, the grip members 52 are made to grip the tool T that should be unloaded to the outside of the tool changing device 100. Thereafter, the arm 50 is pivoted at the predetermined access angle A, and the tool T is disposed at a position closer to the opening 95 than before the pivoting.

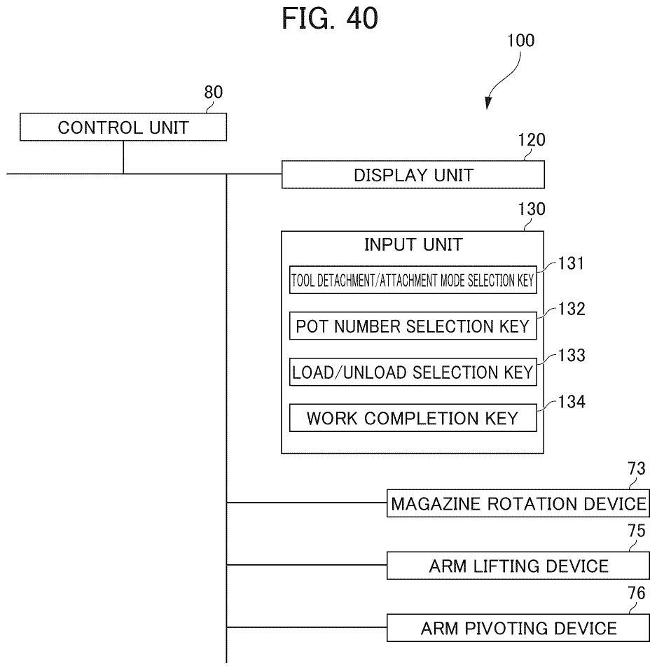

Specifically, as illustrated in FIG. 40, the tool changing device 100 includes a display unit 120 and an input unit 130. The input unit 130 includes a tool detachment/attachment mode selection key 131, a pot number selection key 132, a load/unload selection key 133, and a work completion key 134. The tool detachment/attachment mode selection key 131 is a key for selecting a tool detachment/attachment mode. The pot number selection key 132 is a key for selecting one of the plurality of tool pots 33 included in the magazine 30. The load/unload selection key 133 is a key for selecting one of “loading” and “unloading”.

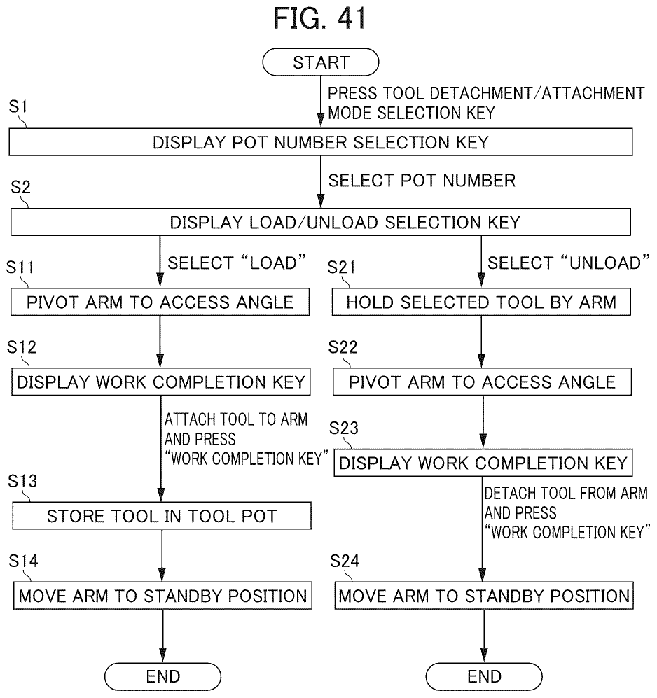

Next, with reference to FIG. 41, a description will be given of a procedure for performing “loading” and “unloading”. In addition, in the following, the alphabet S attached with the reference numerals indicates step.

First, when the user presses the tool detachment/attachment mode selection key 131, the control device 80 causes the display unit 120 to display the pot number selection key 132 in S1. The user selects the pot number by operating the pot number selection key 132 to select one of the plurality of tool pots 33. Thereafter, in S2, the control device 80 causes the display unit 120 to display the load/unload selection key 133. The user selects “loading” or “unloading” by operating the load/unload selection key.

When the user selects the “loading”, the control device 80 rotates the arm 50 to the access angle A in S11. As a result, the grip portion 54 of the grip member 52, which has not gripped any tool T, is disposed near the opening 95. Next, in S12, the control device 80 causes the display unit 120 to display the work completion key 134. Thereafter, the user attaches the tool T related to the “loading” to the grip portion 54 of the grip member 52 from the opening 95, and then presses the work completion key 134. Thereafter, in S13, the control device 80 stores the tool T attached to the arm 50 in the selected tool pot 33. Thereafter, in S14, the control device 80 moves the arm 50 to the standby position W. As described above, the “loading” is completed.

On the other hand, in S2, when the user selects “unloading”, the control device 80 causes the grip member 52 to grip the tool T of the selected tool pot 33 in S21. Next, in S22, the control device 80 rotates the arm 50 to the access angle A to arrange the tool T near the opening 95. Next, in S23, the control device 80 causes the display unit 120 to display the work completion key. Thereafter, the user collects the tool T gripped by the grip member 52 from the opening 95, and then presses the work completion key 134. Thereafter, in S24, the control device 80 moves the arm 50 to the standby position W. Thus, the “unloading” is completed.

According to the present embodiment, as shown in FIG. 38, even in the case where the opening 95 is provided on the front side in the housing 90 and there is no opening in the vicinity of the magazine 30, it is possible for the user to easily load the tool T from the opening 95 and unload the tool T from the opening 95.

### Fourth Embodiment

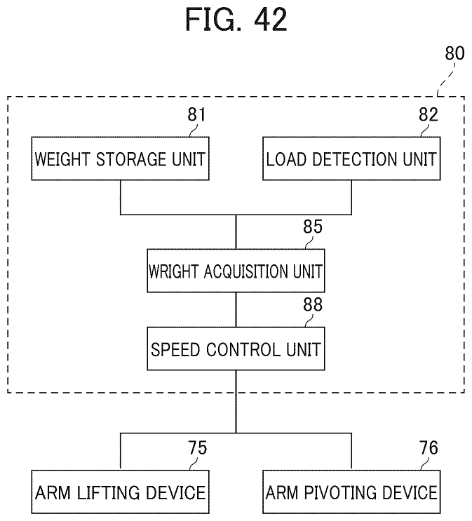

Next, a fourth embodiment will be described based on the first embodiment with reference to FIGS. 42 to 44. However, the present embodiment may be implemented based on the second embodiment or the third embodiment.

In the present embodiment, as shown in FIG. 42, the control device 80 includes a weight acquisition unit 85 and a speed control unit 88. The weight acquisition unit 85 acquires the weight of the previously-used tool Tp and the subsequently-used tool Tn. The speed control unit 88 controls the moving speed of the arm 50 based on the acquired weight. Specifically, when the acquired weight is smaller than a predetermined value, the speed control unit 88 sets the movement speed of the arm 50 to be higher than that when the acquired weight is larger than the predetermined value.

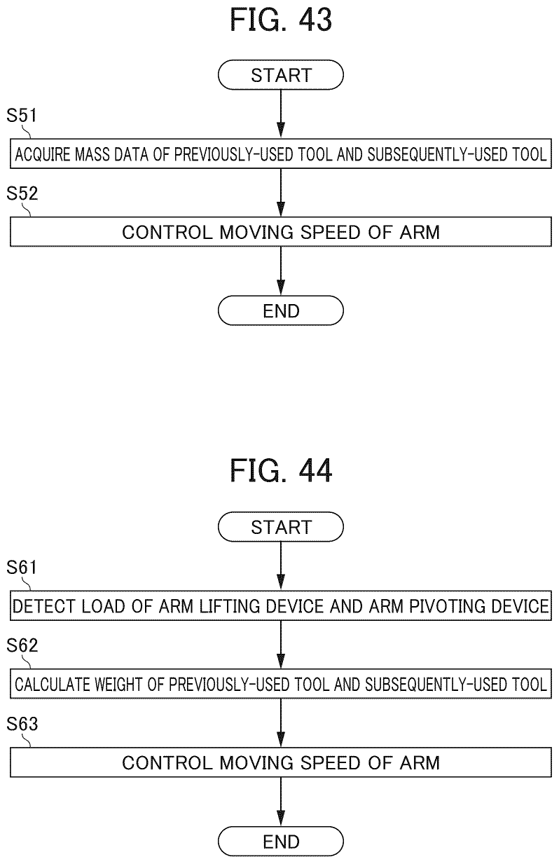

The control device 80 further includes a weight storage unit 81. The weight storage unit 81 stores the weight of the tool T and the pot number of the tool pot 33 in association with each other. The weight acquisition unit 85 calculates the weight of the previously-used tool Tp and the subsequently-used tool In based on the storage. In this case, for example, as shown in FIG. 43, first, in S51, the weight acquisition unit 85 acquires the weight data of the previously-used tool Tp and the subsequently-used tool Tn to calculate the weight. Next, in S52, the speed control unit 88 controls the moving speed of the arm 50 based on the calculated weight.

In place of or in addition to the weight storage unit 81 described above, the control device 80 may include a load detection unit 82. The load detection unit 82 monitors the load of at least one of the arm lifting device 75 and the arm pivoting device 76. The weight acquisition unit 85 calculates the weight of the previously-used tool Tp and the subsequently-used tool In based on the load. In this case, for example, as shown in FIG. 44, first, in S61, the load detection unit 82 detects the load of the arm lifting device 75 or the arm pivoting device 76. Next, in S62, the weight acquisition unit 85 calculates the weight of the previously-used tool Tp and the subsequently-used tool Tn based on the load. Next, the speed control unit 88 controls the moving speed of the arm 50 based on the calculated weight.

According to the present embodiment, it is possible to solve the following problems. It is necessary to move the arm 50 within a range in which an excessive load is not applied to the arm lifting device 75 and the arm pivoting device 76.

However, on the other hand, if the moving speed of the arm 50 is set on the assumption of the maximum weight that the subsequently-used tool Tn and the previously-used tool Tp may have, the moving speed of the arm 50 becomes unnecessarily slow, and the cycle time of tool change becomes unnecessarily long. In this regard, in the present embodiment, when the weight of the subsequently-used tool In and the previously-used tool Tp are small, the moving speed of the arm 50 is set to be higher than that when the weight is large. Accordingly, the moving speed of the arm 50 can be increased within a range in which an excessive load is not applied to the arm lifting device 75 or the arm pivoting device 76. As a result, it is possible to efficiently shorten the cycle time of tool change.

### Other Embodiments

The embodiments described above can be modified as follows, for example. In the first, third, and fourth embodiments, the separation cam 63 and the separation roller 65 may be omitted when the external force to the spindle 215 is not so problematic. Further, in each of the embodiments, when the complicated structure of the tool pot 33 does not pose much of a problem, the holding portion 34 and a shaft as the rotational axis may be provided separately in the tool pot 33.

According to the embodiments described above, it is possible to realize the tool changing devices described in Supplementary Notes 1 and 2 below.

### Supplementary Note 1

A tool changing device (100) for detaching a previously-used tool (Tp) as one of a plurality of tools (T) from a spindle (215) of a machine tool (200) and attaching a subsequently-used tool (Tn) as a tool (T) different from the previously-used tool (Tp) to the spindle (215), the tool changing device (100) including:
a magazine (30) including a rotatable magazine body (39) and a plurality of tool pots (33) attached to the magazine body (39), the plurality of tools (T) being respectively attachable to the plurality of tool pots (33), one of the plurality of tool pots (33) being disposed at an change position (P) by rotation of the magazine body (39);
an arm (50) including a first grip member (51) and a second grip member (52), the first grip member (51) and the second grip member (52) each being rotatable around a direction (Ya) orthogonal to an axial length direction of the spindle (215), the arm being configured, by one of the first grip member (51) or the second grip member (52), to detach the subsequently-used tool (Tn) from the tool pot (33) disposed at the change position (P) and attach the subsequently-used tool (Tn) to the spindle (215) and, by one other of the first grip member (51) or the second grip member (52), to detach the previously-used tool (Tp) from the spindle (215) and attach the previously-used tool (Tp) to the tool pot (33) disposed at the change position (P), and
a grip interlocking mechanism (60) that rotates a grip member on the magazine (30) side of the first gripping member (51) and the second gripping member (52) in conjunction with a movement of the arm (50) relative to the magazine (30) to grip and release gripping of the tool (T), and rotates a grip member on the spindle (215) side of the first gripping member (51) and the second gripping member (52) in conjunction with a movement of the arm (50) relative to the spindle (215) to grip and release gripping of the tool (T).

### Supplementary Note 2

In the tool changing device as described in Supplementary Note 1,
the grip interlocking mechanism (60) includes a magazine-side cam (61), a spindle-side cam (62), and an arm roller (64) that is attached to each of the grip members (51, 52) and moves relative to the magazine-side cam (61) or the spindle-side cam (62) together with the arm (50),
the arm roller (64) of the grip member adjacent to the magazine (30) comes into contact with the magazine-side cam (61) to rotate the grip member adjacent to the magazine (30), and
the arm roller (64) of the grip member adjacent to the spindle (215) comes into contact with the spindle-side cam (62) to rotate the grip member adjacent to the spindle (215).

### EXPLANATION OF REFERENCE NUMERALS

30 magazine
33 tool pot
39 magazine body
50 arm
51 first grip member
52 second grip member
60 grip interlocking mechanism
61 magazine-side cam
62 spindle-side cam
62b gripping cam (spindle-side cam)
64 arm roller
64b gripping roller (arm roller)
100 tool changing device
200 machine tool
215 spindle
P change position
T tool
Tn subsequently-used tool
Tp previously-used tool

What is claimed is:

1. A tool changing device for detaching a previously-used tool as one of a plurality of tools from a spindle of a machine tool and attaching a subsequently-used tool as a tool different from the previously-used tool to the spindle, the tool changing device comprising:
a magazine including a rotatable magazine body and a plurality of tool pots attached to the magazine body, the plurality of tools being respectively attachable to the plurality of tool pots, one of the plurality of tool pots being disposed at an change position by rotation of the magazine body;
an arm including a first grip member and a second grip member, the first grip member and the second grip member each being rotatable around a direction orthogonal to an axial length direction of the spindle, the arm being configured, by one of the first grip member or the second grip member, to detach the subsequently-used tool from the tool pot disposed at the change position and attach the subsequently-used tool to the spindle and, by one other of the first grip member or the second grip member, to detach the previously-used tool from the spindle and attach the previously-used tool to the tool pot disposed at the change position, and
a grip interlocking mechanism that rotates a grip member on the magazine side of the first gripping member and the second gripping member in conjunction with a movement of the arm relative to the magazine to grip and release gripping of the tool, and rotates a grip member on the spindle side of the first gripping member and the second gripping member in conjunction with a movement of the arm relative to the spindle to grip and release gripping of the tool.

2. The tool changing device according to claim 1, wherein
the grip interlocking mechanism includes a magazine-side cam, a spindle-side cam, and an arm roller that is attached to each of the grip members and moves relative to the magazine-side cam or the spindle-side cam together with the arm,
the arm roller of the grip member adjacent to the magazine comes into contact with the magazine-side cam to rotate the grip member adjacent to the magazine, and
the arm roller of the grip member adjacent to the spindle comes into contact with the spindle-side cam to rotate the grip member adjacent to the spindle.
